(19) United States
(12) Patent Application Publication
(10) Pub. No.: US 2014/0224435 A1
(43) Pub. Date: Aug. 14, 2014

(54) Sliding Folding Door System

(71) Applicant: Karl-Heinz Stawski, Cologne (DE)

(72) Inventor: Karl-Heinz Stawski, Cologne (DE)

(73) Assignee: Weinor GMBH & Co. KG, Cologne (DE)

(21) Appl. No.: 14/131,485

(22) PCT Filed: Jul. 25, 2012
(86) PCT No.: PCT/EP2012/003137

§ 371 Date: Feb. 24, 2014

(30) Foreign Application Priority Data
Aug. 17, 2011 (DE) 10 2011 110 411.2
Oct. 11, 2011 (DE) 10 2011 115 536.1

(51) Int. Cl. E06B 3/48; E05D 7/00; E05F 15/00; E05D 15/06

(52) U.S. Cl. CPC E06B 3/481; E06B 3/486; E05D 15/0621; E05D 7/00; E05F 15/00
USPC 160/188; 160/199; 160/203; 160/192

(57) ABSTRACT

The invention relates to a sliding door system having a frame (1, 1′, 2, 2′), which receives one or more sliding doors that, mounted in or on the frame (1, 1′, 2, 2′), can be moved horizontally along the frame (1, 1′, 2, 2′), wherein the sliding doors are constructed as folding door elements (11, 12, 13), in which two door elements (14, 15) are connected to each other in a hinged manner by means of a joint arrangement running vertically centrally between the door elements, wherein the joint arrangement can be pivoted out of the plane of the frame, such that the two door elements (14, 15) can be opened at right angles to the plane of the frame and lie flat on each other in an open position.

The invention relates to a sliding folding door system with a frame which holds one or more sliding doors which supported in or on the frame can be moved horizontally along the frame.

DE 10 2008 063 765 A1 discloses a sliding door system with a frame which holds one or more door elements which are guided in the frame and which can be moved horizontally along the frame from a closed position into an open position, the door elements in the open position being pivotable out of the plane of the frame, i.e. out of a position which is parallel to the frame, into an open position, the sliding door system at least in the region of the top of the door element and of the frame having a detachable locking arrangement which has an unlockable blocking element which when the door element has been moved horizontally into the open position interacts with a corresponding counterpart and forms a positive connection and blocks horizontal movement of the door element in the frame and at the same time allows pivoting of the door element out of the plane of the frame, i.e. out of a position which is parallel to the frame.

This disadvantage in this sliding door system is that in addition to the bearing rollers on which the door elements are movably supported in the guide rails, there must be a plurality of components and assemblies such as for example locking apparatus for locking of the door element against movement in the guide rail with the door element open in order to prevent tilting. In this way the overall construction and installation become very complex.

In this sliding door system it is furthermore disadvantageous that at a large length-width ratio of the door elements the latter can tilt when moving along the plane of the frame, limits being imposed against a wider execution of the door elements since they otherwise take up too much space when the door elements are pivoted out of the plane of the frame.

Another disadvantage is that the sliding revolving doors of this system cannot be opened at just any position, but only at one defined position is the pivoting of the door out or the plane of the frame possible.

Furthermore folding door systems are known in which a plurality of door elements are hinged to one another in the manner of an accordion, the door elements being arranged movably in a frame. But they are not sliding door systems since it is not possible to move and open individual elements since all door elements are coupled to one another. These folding doors are coupled on one side to the frame so that opening is possible only in one direction, the folding door elements however cannot move freely. It is furthermore disadvantageous in folding door systems that they can only be managed with great difficulty due to the coupling of all door elements among one another, and in part even operation can take place only by two individuals.

Another disadvantage is the uncontrolled opening behavior of these folding door systems which results from the fact what when the coupled folding doors are pushed together in order to open the folding door system individual door elements are deflected out of the initial position to different degrees and the hinges which have been deflected out of the plane of the frame are not aligned. Altogether this results in only unsatisfactory operability of these folding door systems.

It is furthermore disadvantageous in these folding door systems that the individual door elements cannot be cleaned from the outside since individual elements cannot be opened. Cleaning from the outside is therefore only possible in these folding door systems to the extent the entire folding door system is freely accessible from the outside.

The object of the invention is to overcome the indicated disadvantages and to develop a sliding door system of the initially named type such that movement of the door elements horizontally along the frame from a closed position into an open position and vice versa is easily possible and in the open position a pivoting of the door into an open position with the door held securely is possible without the door being able to tilt at the instant of pivoting, and the door system will have a simple overall construction and the number of components and assemblies is reduced.

This object is achieved as claimed in the invention by a sliding door system according to Claim 1. Advantageous developments of the invention are given in the dependent claims.

In the sliding door system with a frame which holds one or more sliding doors which can be moved supported in or on the frame horizontally along the frame, it is especially advantageous that the sliding doors are made as folding door elements in which two door elements are hinged to one another by means of an articulated arrangement on a hinge line which runs in the middle vertically between the door elements, the articulated arrangement being pivotable out of the plane of the frame so that the two door elements can be pulled out perpendicular to the plane of the frame and lie in one open position flat on one another.

That the two door elements lie flat on one another in the open position means that on the hinge line a small, very acute angle is included which in the ideal case assumes 0°. But to the extent an angle of 0° cannot be achieved due to the geometry for example of bearing rollers on which the door elements are supported in or on the frame, either an easily opened parked position in which the two door elements include an acute angle can be intended, or the articulated arrangement is made such that the door elements run parallel in the completely folded position, but have a small distance from one another.

Here movement of the folding door elements in the horizontal direction along the frame into a desired open position or vice versa from the open position into the closed position is easily possible since the folding door elements are movably supported in or on the frame. In the closed position all sliding door elements are next to one another in the plane spanned by the frame and form a closed wall, in the case of glass doors a closed glass wall, as can be provided for example in conservatories. On the upper and/or lower side of the door there can be a lock or locks which engage in the closed position of the respective folding door element and reliably close the folding door elements.

The term “plane of the frame” means the plane spanned by the frame which holds the sliding doors.

If the folding door element has been moved out of its closed position into the desired open position, the door elements which are coupled to one another can be pivoted out of the plane of the frame. The hinge action of the articulated arrangement by means of which the two door elements are connected thus allows the two door elements to be pivoted out of the plane of the frame so that the door elements can be pushed together on one side of the frame to form a package so that the entire width of the frame which in the completely closed position of the folding door elements forms a closed wall can be opened. This is especially advantageous for example in a conservatory or an entry region of a business or the like.

In the completely opened position thus all sliding door elements are pushed together to form a package perpendicular to the plane of the frame of upright folding door elements so that almost the entire frame width is cleared and opened. In the completely closed position on the other hand the folding door elements form a closed surface in the plane which is spanned by the frame, for example a closed glass wall in the case of sliding glass doors.

The plane of the frame here designates the plane which is spanned by the frame of the sliding door system and in which the folding door elements lie in the closed position. In the opened position the door elements of the folding door elements are perpendicular to this plane and form a package which has been pushed to the side so that an opening as wide as possible, i.e. a maximum opening, is achieved.

Here a very favorable height-width ratio of the folding door elements can be achieved. Because two door elements are always hinged to one another by means of an articulated arrangement on a hinge line which runs vertically in the middle between the door elements, the folding door is altogether twice as wide as an individual door element so that when the folding door element is moved along the frame tilting and canting are reliably prevented, while the door elements when being pulled out, i.e. in the pivoting of the hinge line on which the two door elements are connected to one another out of the plane of the frame take up little space and can be pushed together into a package whose extension perpendicular to the plane of the frame corresponds only to half the width of a folding door element, specifically the width of an individual door element.

To close the front or glass front which is formed by the door elements within the frame, each door element is pivoted out of the pivoted-out position, i.e. out of the position perpendicular to the plane of the frame back again into the plane of the frame.

The sliding doors thus have two door elements which are joined to one another via a middle joint with a vertical pivoting axis and thus form a folding door element. It is possible for one guide element in the alignment of the pivoting axis of the middle joint to engage a guide rail of the frame, by disengaging this guide element a pivoting out of the plane of the frame being possible, especially the folding door can be folded together at any position of the frame.

Alternatively it is possible for there not to be a guide element so that the folding door can be folded at any position by the middle joint of a folding door element being pivoted out of the plane of the frame and the two door elements of the folding door forming an angle between one another or being able to be pushed together into a flat package and standing in this position perpendicular to the plane of the frame and lying flat on one another.

The sliding doors can be supported suspended or upright in or on the frame.

In suspended support of the sliding doors in or on the frame preferably on the bottom end of the folding door elements which form the sliding doors there are guide elements which engage the lower frame in order to prevent pivoting of the folding door elements perpendicular to the plane of the frame, i.e. on an arc around the upper support.

In upright support of the folding door elements which form the sliding doors, preferably on the upper end of the folding door elements there is at least one guide element which engages a guide rail on the upper frame and reliably prevents tilting of the folding doors out of the plane of the frame.

Preferably the sliding doors on their left side and on their right side have bearings which can move up and/or down in a guide rail of the frame, especially castors and/or sliders by means of which they are movably supported in a guide rail of the frame.

When the articulated arrangement, i.e. the middle joint of the door elements, is pivoted out, these bearings in the plane of the frame remain engaged to the guide rail of the frame.

Because the engaged bearings of the sliding doors, i.e of the folding door elements are each located on the left side and on the right side, altogether there is maximum stability of the support of the folding door elements in or on the frame. Tilting of the sliding doors when being moved is effectively prevented in this way.

In one preferred embodiment the sliding doors can be moved in any directions along the frame and can be folded together both on the left end of the frame and also on the right end of the frame.

The leaf packages can thus be moved in two directions along the frame. Thus all folding door elements can be pushed together on the left side or can be pushed together on the right side of the frame or one part of the folding door elements on the left side can be parked in the open position while the remaining folding door elements on the right side of the frame are parked folded together in the open position in order to achieve maximum opening of the frame.

Preferably the sliding door system on the left and/or right side has a wing and/or sliding wing, especially in the form of a glass door, the wing being coupled to the frame by means of hinges.

The wing which is coupled to the frame by means of hinges can be opened to the inside and/or outside, i.e. it can be pivoted out into a position in which it forms a 90° angle to the plane of the frame so that after opening this wing the folding door elements can likewise be pulled out and pushed into an open position on the side so that the door elements altogether form a flat package on the side of the frame, this package being perpendicular to the frame of the plane.

In a sliding door system with an even number of leaves two leaves at a time can be folded and moved in the package.

In a sliding door system with an odd number of leaves there is a single wing which is coupled by means of hinges to the frame on one side of the sliding door system, all other leaves in turn being located in packages of two leaves each with a capacity to be folded and moved. Preferably the folding door elements can be pushed together on that side on which there is a wing. But different arrangements are also possible.

In particular it is also possible to provide one wing at a time on the two sides for an even number of leaf elements.

In a sliding door system in which one part of the folding door elements is moved and folded to the left and the other part of the folding door elements is moved and folded to the right for opening, both symmetrical and also asymmetrical divisions are possible.

Inside and outside mean looking at the sliding door system, by means of the sliding door system an inner region being delineated by an outer region, such as for example for a conservatory or for a balcony. To the extent on the outside of the sliding door system, such as for a balcony, there is still a stationary railing, both wings which can be optionally arranged and also the folding door elements can only be pulled out only to the inside, since the outer region is bordered by the stationary railing.

In the case of a conservatory, the wings and the folding door elements can be made and arranged such that they are pivoted or folded either to the inside or are pivoted and folded to the outside or allow opening and folding both to the inside and also to the outside. This results in maximum flexibility of the system. The different configurations can be implemented by corresponding execution of the bearings of the door elements in or on the frame and of the articulated arrangement between the two door elements.

Preferably the sliding doors and/or wings have a safeguard, especially a pin safeguard and/or a spring-loaded catch against unwanted opening.

On the one hand, this prevents unauthorized opening from the outside and also unwanted opening for example under the force of the wind.

Cumulatively or alternatively there can be a lock, especially a closable lock, especially a circle boltlock and/or a slide lock such as a briefcase lock.

There is preferably a lock on the wing. Especially preferably each folding door element can be locked and folded individually in any position by locking and unlocking.

Preferably the sliding doors in the region of the articulated arrangement, especially in the axial alignment of the axis of rotation of the articulated arrangement, are supported to be able to move by means of a castor and/or slider in a guide rail of the frame, the guide rail in one open position of the sliding door having a recess so that the castor and/or slider which is located in the region of the articulated arrangement especially in the axial alignment of the axis of rotation of the articulated arrangement can emerge perpendicular to the plane of the frame out of the guide rail and thus out of the plane of the frame.

Especially preferably the sliding doors in the region of the articulated arrangement, especially in the axial alignment of the axis of rotation of the articulated arrangement by means of a castor and/or a slider and/or a pin a guide rail of the frame movably engage, the castor and/or slider and/or pin located in the region of the articulated arrangement, especially in the axial alignment of the axis of rotation of the articulated arrangement, can be disengaged from the guide rail so that the region of the articulated arrangement can emerge perpendicular to the plane of the frame out of the guide rail and thus out of the plane of the frame.

This means, if the articulated arrangement emerges perpendicular to the plane of the frame out of the guide rail and thus out of the plane of the frame, that the axis of rotation which lies in the plane of the frame with the folding door closed is shifted into a position in which the axis of rotation runs spaced apart from the plane of the frame parallel to the latter. The folding door elements are lined up here and then folded together since the two door elements which are hinged to one another then form an angle which becomes more and more acute or lie flat on one another when pivoted completely out and include an angle of 0°. In this especially preferred embodiment each leaf package can be disengaged from the guide rail and thus can be folded and opened individually in any position by locking and unlocking.

Especially preferably the two door elements of the folding door elements are made as glass doors, especially as frameless glass doors. Alternatively it is also possible for other materials such as aluminum doors or the like to be used.

A visually especially pleasing overall design however results when all wings and door elements of the folding door elements are made as glass doors since then a glass wall which extends over the entire frame in the closed state is formed.

To the extent the door elements of the folding door elements are made as glass doors, they are preferably formed from safety glass and/or insulating glass. When using insulating glass the sliding folding door systems as claimed in the invention can also be used in a warm region, i.e. for example in heated conservatories or as a living room closure toward a terrace. The use of the sliding folding door system is not limited thereto, since it can also be used in a cold region, therefore for unheated conservatories and the like.

In one embodiment with folding door elements in the form of glass doors which are formed from insulating glass, the sliding folding door systems can also be used in a warm region, i.e. for example in heated conservatories or as a living room closure toward a terrace. Here the glass doors have insulating glazing. The insulating glazing can be made frameless or insulating glass panes can be provided in frames and form the folding door elements. In order to achieve optimum insulation and sealing, these frames can have seals. The seals can be made in particular such that on the articulated connection of the two door elements a rubber lip or the like on one door element engages a U-shaped or V-shaped recess or groove and/or there is a compression seal in order to seal in the closed state the folding door element in the region of the articulated connection of the two door elements against the environment. These seal arrangements of a lip and a U-shaped or V-shaped recess or groove and/or compression seals are preferably also located on the outer edges of the folding door elements in order to ensure effective sealing of the entire system in the closed state of the sliding folding door system. These seals on the one hand cause sealing of the folding door elements among one another on the contact regions, and furthermore sealing of the folding door elements against the frame.

The folding door elements or the two door elements which form the folding door elements can be made in almost any height/width ratio. But preferably the maximum side ratio for a single door element of height to width is equal to 5 to 1.

In one especially preferred embodiment the frame is formed by several frame sections which have one or more angles so that several planes of the frame are formed which include an angle with one another, the sliding doors being movable in particular beyond the angle along the frame sections, especially by the articulated arrangement leaving the plane of the frame of a first frame section when the sliding doors have travelled horizontally along the first frame section up to the angle and the direction of travel from the plane of the frame of the first frame section to the plane of the frame of the following frame section is changed until the two sliding door bearings lie in the plane of the frame of this second frame section.

The frame sections are especially preferably connected among one another such that travel of the folding doors beyond the angle between the frame sections is possible, for example by the guide rail being made continuous and especially having a radius instead of a sharp kink. The travel of the folding doors beyond the angle is especially possible in that the articulated arrangement leaves the plane of the frame of the first frame section when the sliding doors have travelled horizontally along the first frame section up to the angle and the direction of travel from the plane of the frame of the first frame section to the plane of the frame of the following frame section is changed until the two sliding door bearings have entered the plane of the frame of this second frame section and thus also the joint axis between the two door elements has entered the second plane of the frame. This process of movement thus describes the displacement over an angle when the folding door element is not folded.

Alternatively the folding door element however can already be lined up before reaching the angle region by the articulated arrangement being pivoted out of the first plane of the frame. Then the folding door element in the folded, i.e. pulled-out state, can travel beyond the angle into the second plane of the frame.

It is thus possible, for example in conservatories, to make this sliding door system as an angle system so that two or three sides of the conservatory are altered by means of the sliding door system.

The angles included between the frame sections can be right angles. But any angle other than a right angle is also possible, in particular interior angles of 135° can be formed, as in a stop sign. But also interior angles which are smaller than a right angle can also be formed, if this is structurally desired. Preferably these angle systems can have any interior angles in the range from 90° to 180°.

By pivoting the articulated arrangement out of the plane of the frame until for example an acute angle is included between the door elements, travel of the folding door element along the frame and beyond an angle is possible without the rails of the frame in the angle being brushed over to the outside by the folding door element. Thus this arrangement is also suitable for balconies in which on the outside of the frame there being a balustrade and travel of the folding door elements beyond the angle is possible.

These angle systems make it possible to move the folding door elements beyond the angle of the frame in order to open several sides, for example of a conservatory, at the same time and to enable a visually very pleasing overall impression with maximum manner of opening.

Preferably in the sliding door system there are a plurality of folding door elements which can be moved on one or both sides along the plane of the frame to an open position, and the folding door elements can be pulled out by the respective articulated arrangement being pivoted out of the plane of the frame so that the folding door elements on one or both sides of the frame in the open position form a package of door elements which lie flat on one another.

In an arrangement of a wing on the side of the frame this wing in the opened position can form the first layer of this package of door elements which lie flat on one another.

When the sliding door system is being completely opened, all door elements are thus pulled out perpendicular to the plane of the frame and are partially pushed together on one side or two sides in order to achieve a maximum opening width.

In one preferred embodiment the articulated arrangement has a locking device by means of which the articulated arrangement can be locked regardless of the angle, especially at an acute angle between the two door elements so that pivoting motion of one door element against the other door element is blocked.

By means of this locking device of the articulated arrangement by means of which the two door elements of the folding door element are hinged to one another on the hinge line which runs vertically in the middle between the door elements the two door elements can be blocked and fixed in any desired position in order for example to open only one gap when wind forces are great and to prevent further automatic opening under the force of the wind when this is desired.

The folding door element at a certain opening position, for example at an acute angle included between the door elements, for example 30°, can be blocked by this locking device of the articulated arrangement in order to facilitate the movement of the folding door along the frame and to avoid tilting of the folding door which possibly could occur in complete opening, i.e. when the two door elements lie flat or almost flat on one another. It has been shown that the movement along the frame is facilitated when a certain acute angle between the two door elements is reached, and complete pivoting into the open position in which the two door elements run parallel or almost parallel to one another only takes place when the desired parked position in the frame is reached.

Preferably this locking device is executed such that at an acute angle of for example 30° the door elements are automatically detachably blocked in order to facilitate the movement of the folding door element along the frame and to prevent tilting of the folding door element, in travel of the door element which has been locked with an acute angle against the frame on the side or against another door element which is already in the parked position on the side of the frame the locking automatically releases so that the door elements can be pushed together until they lie flat on one another.

The locking device can be formed by a scissors system, when the door elements are lined up, latching taking place when the door elements have reached a certain acute angle, a release mechanism being actuated when the folding door element is moved against the frame or against a folding door element which has already been moved in the open position, i.e. in the parked position so that the locking device is released and the folding door element can be pushed together flat.

Preferably the locking device can be manually unlocked in any position of the folding door element within the frame.

If the sliding folding door system is to be closed again, the door element of each folding door element, which former door element is the front element in the closing direction, is pulled again in the closing direction, in turn automatic locking taking place by the locking device when the acute angle between the two door elements is reached, as a result of which the movement of the folding door element along the frame is facilitated. When the closed position is reached, the locking device is manually released in order to pivot the pulled-out door elements back again into the plane of the frame.

Preferably the articulated arrangement has a locking device by means of which the articulated arrangement can be locked at an angle of 180° between the two door elements so that a pivoting motion of one door element against the other door element is blocked.

This locking device of the articulated arrangement at an angle between the door elements of 180° stops unauthorized or unwanted opening of the folding door element and furthermore movement along the frame is facilitated.

Preferably the articulated arrangement has a locking device which is formed by a clip which is coupled to one door element and whose free end is guided by means of a crank guide with respect to the other door element, the crank guide having at least one locking position in which the clip detachably latches so that the articulated arrangement is locked in at least one intermediate position between the closed position and complete opening, especially at an acute angle between the two door elements so that a further pivoting motion of one door element against the other door element in this intermediate position is blocked.

Preferably this clip is made such that by means of this clip detachable locking of the articulated arrangement can take place at an angle of 180° between the two door elements and at at least one other angle, especially an acute angle, especially in the range between 30° to 60° between the two door elements.

The crank guide can be implemented by a pin which is located on the free end of the clip and which engages a crank guide on the hinge part or a frame part of the second door element, this crank guide having a locking position or catch position so that detachable locking in the desired angle position of the two door elements to one another is formed.

But it is also possible to arrange a crank guide in the clip which is engaged by a pin located on the hinge part or frame part of the second door element, this crank guide having a locking position or catch position so that detachable locking in the desired angle position of the two door elements to one another is formed.

Preferably the articulated arrangement has a locking device which is formed by an axially movable, especially spring-loaded hinged pin which is located torsionally strong to a first hinge part and has a feather key which in the disengaged axial position engages a groove of a second hinge part and locks the articulated arrangement so that a pivoting motion of one door element against the other door element is blocked.

The angle position of the groove in the second hinge part into which the feather key of the axially disengageable hinged pin travels and locks the articulated arrangement is chosen such that the locking device engages at the desired angle between the two door elements.

Preferably the axially disengageable hinge pin and the hinge parts which form the hinge are made such that by means of this arrangement detachable locking of the articulated arrangement can take place both at an angle of 180° between the two door elements and at at least one other angle, especially an acute angle, especially in the range from 30° to 60° between the two door elements.

In one preferred embodiment the articulated arrangement has a locking device which is formed by a flexible strip which extends around the articulated arrangement on the outside and which is attached to one door element and whose free end has a catch element which in at least one intermediate position travels detachably into a recess on the other door element so that the articulated arrangement is blocked in at least this intermediate position between the closed position and complete opening, especially at an acute angle between the two door elements so that further pivoting motion of one door element against the other door element in the intermediate position is blocked.

The recess into which that catch element on the free end of the flexible strip travels is positioned such that the locking takes place at the desired angle between the two door elements. The flexible strip can run in guides so that it is not lifted off the articulated arrangement when the angle included between the door elements is increased and in the opposite direction of motion it is ensured that the catch element engages the recess. The catch element can be formed for example by a bolt which runs transversely on the free end of the strip and which projects over the strip on either side. This bolt is thus suited to be used as a catch element and to travel in a correspondingly arranged recess and to block further movement.

An acute angle as an angle included between the two door elements, especially an angle in the range from 30° to 60°, has proven advantageous for the manageability of a folding door element especially when moving along the frame or for cleaning the door elements.

Preferably the articulated arrangement has at least one pretensioned spring, especially a leaf spring and/or torsion spring which when an opening angle of 180° between the two hinged door elements is not reached causes a reduction of the angle included between the two hinged door elements and thus automatic folding of the folding door element.

By means of this pretensioned spring of the articulated arrangement the folding and lining up of the folding door elements are simplified since then they automatically push into the open position. This pretensioning in the articulated arrangement between the two door elements thus causes the holding door to be automatically lined up if the pretensioning is made large enough, or at least support of manual opening and folding of the folding door when the pretensioning is made somewhat smaller.

Preferably the articulated arrangement between the two hinged door elements is detachable in order to be able to line up the two door elements independently of one another and to be able to move along the frame. In particular the articulated arrangement can be formed by one or more hinges, hinge parts which can be turned against one another being coupled by means of bolts, the bolts being axially movable at least insofar as one hinge part is released.

Because the articulated arrangement between the two hinged door elements is detachable, the two door elements on the hinge line are separable from one another and can be hinged to one another. This is especially advantageous in the installation of the sliding folding door system by the door elements being able to be inserted individually into the frame and so that by means of the articulated arrangement they can be hinged to one another. Furthermore, because the articulated arrangement is detachable, maintenance and repair efforts are facilitated since the two door elements of each folding door element can be lined up independently of one another, i.e. can be pivoted out of the plane of the frame. This also facilitates the cleaning of the door elements.

One exemplary embodiment of the sliding door system is shown in the figures and is detailed below.

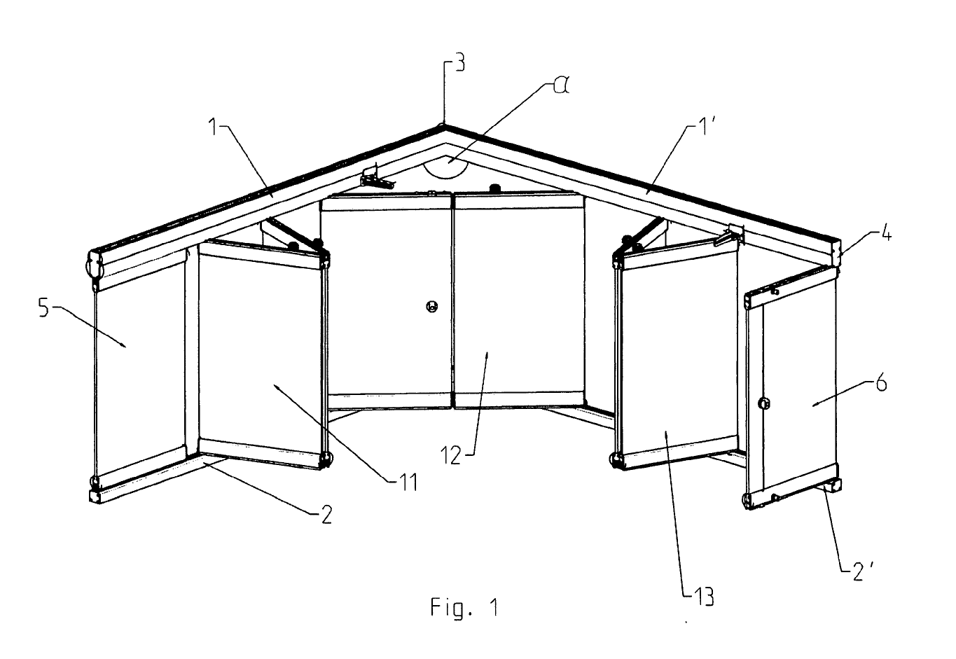

FIG. 1 shows a sliding door system in an angle execution in a perspective view;

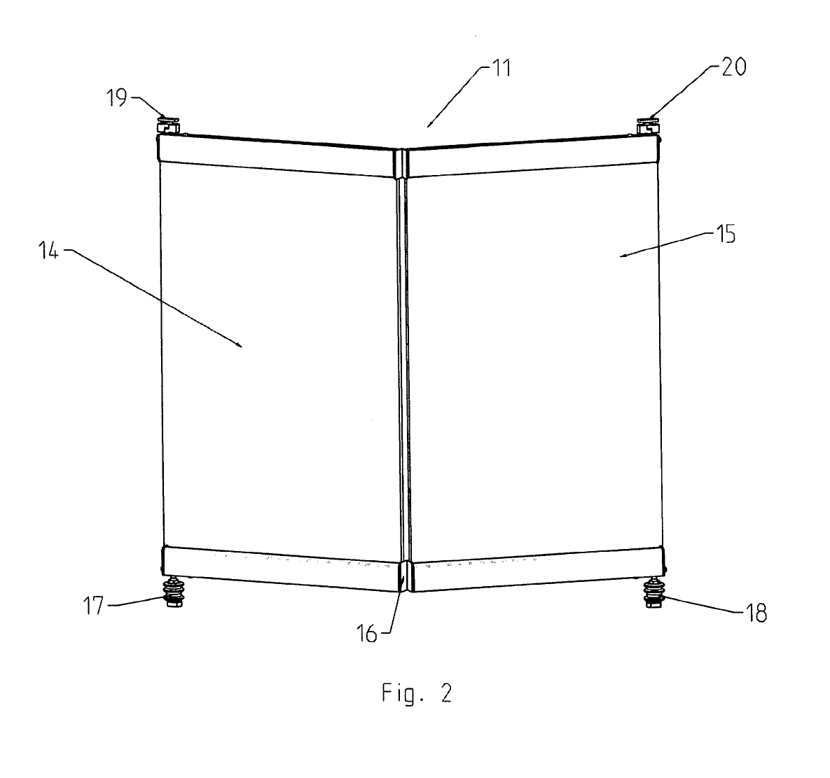

FIG. 2 shows a folding door element of the sliding door system as shown in FIG. 1 in a perspective view;

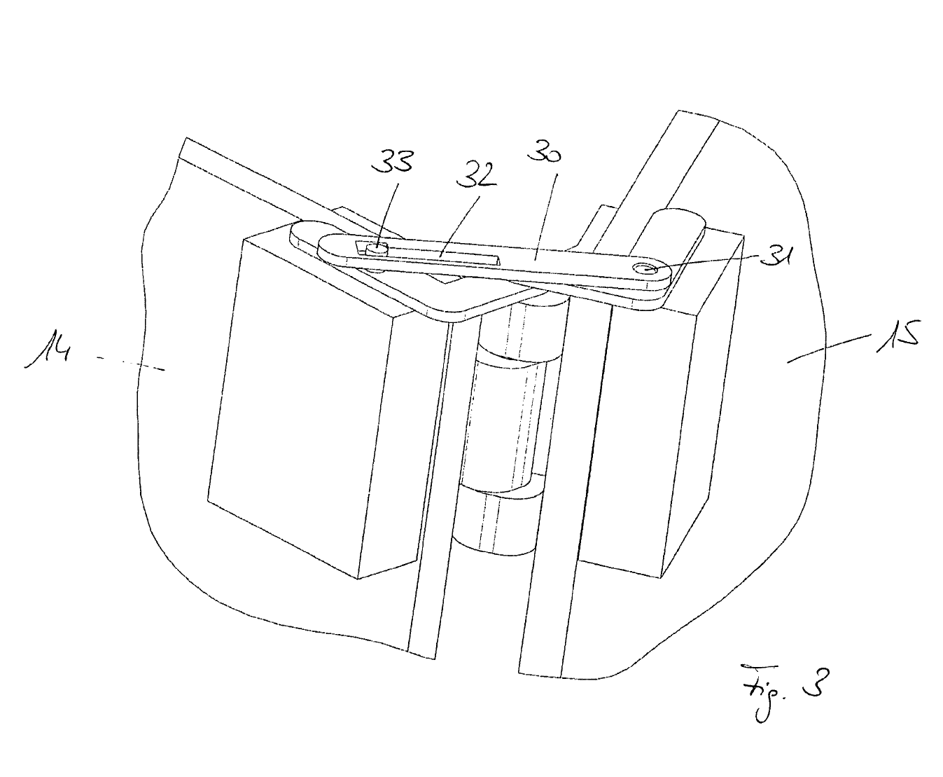

FIG. 3 shows a first embodiment of a joint locking device;

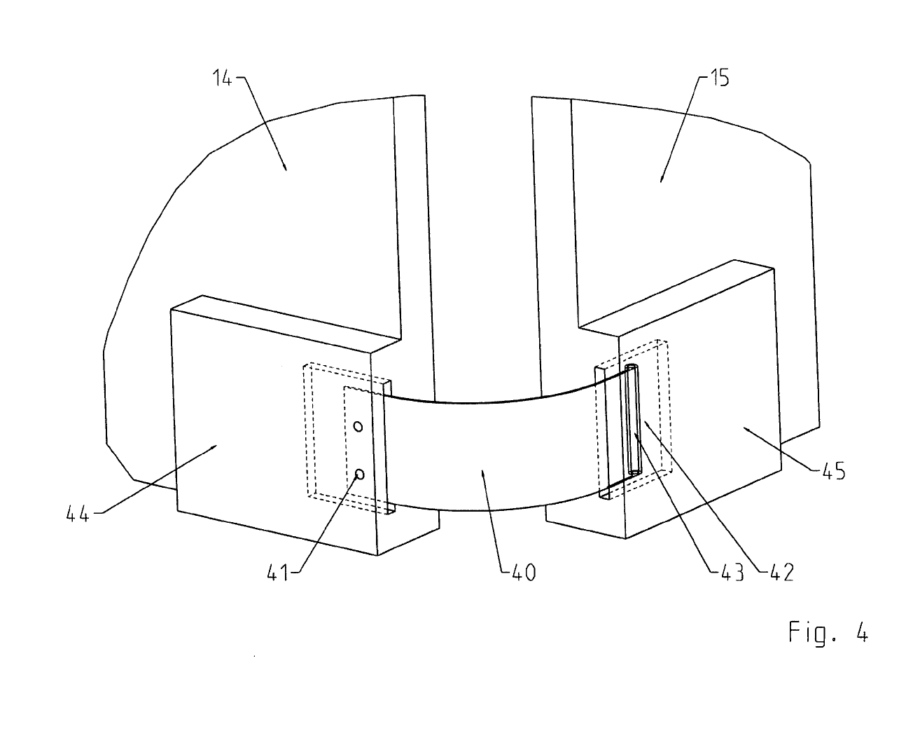

FIG. 4 shows a second embodiment of a joint locking device;

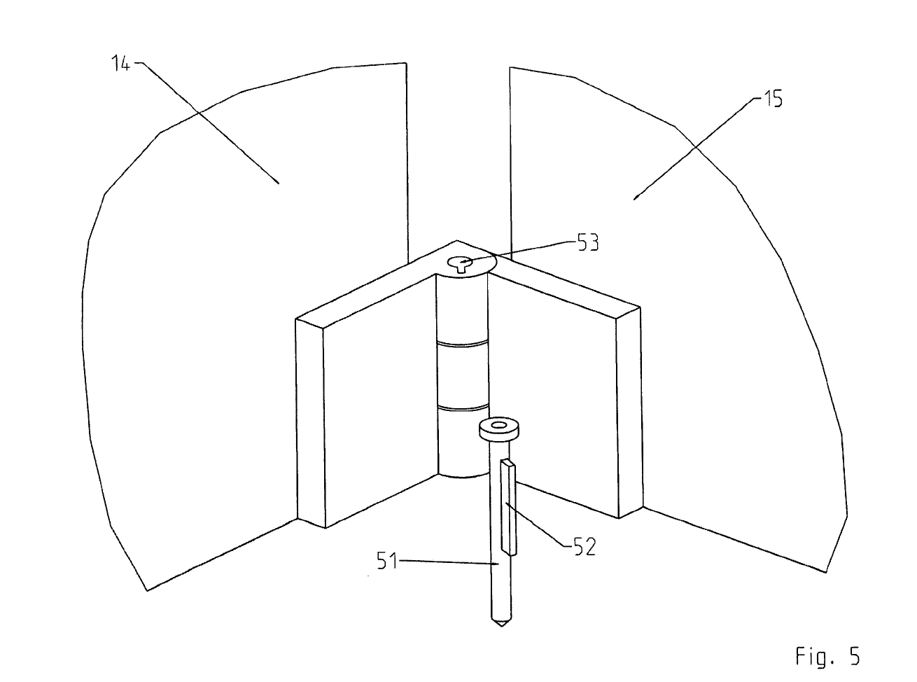

FIG. 5 shows a third embodiment of a joint locking device.

The terms sliding door system and sliding folding door system are used synonymously for description of the invention.

FIG. 1 shows a perspective view of a sliding door system in a version of an angle system. Here a second frame section adjoins a first frame section, which among one another include an angle α. The first frame section is formed by an upper frame 1 and a lower frame 2. The second frame section is funned by an upper frame 1′ and a lower frame 2′. The interior angle α is a right angle so that a rectangular outer corner of a conservatory can be altered by means of the angle system according to FIG. 1.

On the left side of the first frame section there is a sliding revolving door 5 which on its right edge is movably supported with a lower roller bearing in the lower frame 2 and is guided by means of an upper guide in a guide rail in the upper frame 1.

On the right side in the plane of FIG. 1 the angle system has a stationary revolving door 6 which is coupled via hinges to the frame 1′, 2′ of the second frame section and as shown in FIG. 1 can be pulled out of the plane of the frame toward the inside of the angle system.

Furthermore the sliding door system as shown in FIG. 1 has three folding door elements 11, 12, 13, as is shown enlarged in FIG. 2.

The folding door elements 11, 12, 13 are each formed by two door elements 14, 15 which are hinged to one another in the middle, as is shown in FIG. 2. The folding door elements 11, 12, 13 have an identical structure. There are joints on the hinge line 16 which runs vertically between the door elements 14, 15 so that the folding door elements 11, 12, 13, as shown in FIGS. 1 and 2, can be folded by the articulated arrangement, i.e. the hinge line 16 being pivoted out of the plane of the frame toward the inside of the angle system.

The revolving door elements 5, 6 and the door elements 14, 15 of the folding door elements are formed by glass doors, i.e. panes. All panes of the sliding door system as shown in FIG. 1 run next to one another on the lower guide rail 2, 2′. A frameless construction, as indicated in FIG. 1, yields high transparency. The upper frame profile 1, 1′ is only used for guidance of the leaves which are movably supported on the lower frame 2, 2′.

The lower frame profile 2, 2′ is used for reliable accommodation and support of the movable folding door elements 11, 12, 13 and of the sliding wing 5 and is used to divert the support forces from the glass panes into the foundation.

In order to avoid a collection of rain water in the lower frame 2, 2′ the guide rails which have been integrated into it have water outlet openings toward the outside.

As is shown in FIG. 1 using the folding door element 12, movement of the folding door elements over the angle 3 of the sliding door system according to FIG. 1 in the direction to the right end 4 of the angle system is easily possible. On this lateral end 4 of the angle system the revolving door 6 is installed stationary and coupled to the frame 1′, 2′ with hinges so that the revolving door 6 can be pulled out vertically as shown in FIG. 1.

The folding door element 13 can be moved completely against this revolving door 6 as far as against the end 4 of the angle system. The same applies to the other folding door elements 12 and 11.

Since the sliding revolving door 5 is supported only on its right side, movement of the sliding revolving door 5 beyond the angle 3 in the direction to the right end 4 of the system is also possible here. Furthermore the slide bearings of the sliding revolving door 5 allow the door to be pulled out by 90° perpendicular to the plane of the frame so that in the completely opened state a flat package of door elements which lie on one another is formed in the region of the right end 4 of the angle system so that more or less the entire region of the sliding door system as shown in FIG. 1 can be opened.

FIG. 2 shows in a perspective view a folding door element 11 which is formed from two door elements 14, 15. The two door elements 14, 15 in the middle have a connecting line 16 on which they are hinged to one another.

The folding door element 11 is supported upright in the lower frame 2, 2′ and for this purpose has corresponding castors 17, 18. The castors 17, 18 engage guide rails of the lower frame 2, 2′.

On the upper end the folding door elements have only guides 19, 20 which prevent the folding door elements 11 from tipping out of the plane of the frame.

The castors 17, 18 and the guide elements 19, 20 are not rigidly attached to the door elements 14, 15, but can turn.

Relative movements are possible between the left door element 14 and the castor 17 and between the door element 14 and the upper guide element 19. The same applies to the right door element 15. Relative movements are also possible between the right door element 15 and the castor 18 and between the door element 15 and the upper guide element 20.

The door elements 14, 15 can thus turn against the castors 17, 18 and against the guide elements 19, 20 so that travel of the folding door elements 11 beyond the corner 3 of the angle system according to 1 is possible and the door elements can pivot out of the plane of the frame. In the completely opened state the joint on the hinge line 16 allows an angle of 0° so that the two door elements 14, 15 lie flat on one another and can be pushed together flat on the right end 4 of the angle system. This flat lining-up of each folding door 11, 12, 13 is however also possible at any other site of the angle system as shown in FIG. 1 in order for example to open a small region of the conservatory in order to be able to go outside.

The corner 3 of the angle system as shown in FIG. 1 is made as a right angle with an interior angle of α=90°.

In contrast to FIG. 1, the angle α can also assume any other value, in particular any angle between 90° and 180° is possible. But especially preferably angle systems with an interior angle α of 90° and 135° are made as standard versions so that the frames 1, 1′ and 2, 2′ and the angle transition elements can be made as a modular system.

Since the folding doors 11, 12, 13 can be folded to the inside and lined up as shown in FIG. 1, the door elements of these folding doors 11, 12, 13 can be easily cleaned. Even if it is a balcony with a peripheral balustrade and a railing which is located on the outside of the sliding door system, by lining up the folding door elements in a manner such that the two door elements 14, 15 include an acute angle, it is possible to reach around the folding door elements so that the outsides of the glass panes can also be easily cleaned since they are then easily accessible.

The high flexibility is especially advantageous to the system since even alteration of one corner, as is shown in FIG. 1, is possible, the sliding door system as claimed in the invention allowing even movement of the folding door elements beyond the corner 3 of the angle system.

The figures do not show locks provided on each door element and which engage the upper frame 1, 1′ and prevent unauthorized opening both of the sliding revolving door 5 and the revolving door 6 as well as of the folding door elements 11, 12, 13 from the outside.

There can be handles on the door elements for easy handling of the door elements 5, 6, 11, 12, 13. In particular the locking elements can be actuated via these handles. At the same time folding of the folding door elements 11, 12, 13 can be effected via these handles so that handling of the entire sliding door system is facilitated.

The arrangement of a locking device of the joint of the folding door elements 11, 12, 13 has shown itself to be especially advantageous. This locking device of the joint is helpful on the one hand when the folding door elements 11, 12, 13 are moving along the frame. Furthermore this locking device is also favorable at for example an acute angle between the folding door elements 14, 15 in order to lock the folding door elements 14, 15 in such a position to clean the panes.

FIGS. 3 to 5 show different embodiments of joint locking devices.

In the first embodiment of a joint locking according to FIG. 3 device there is a clip 30 above the articulated arrangement. This clip 30 on its right end is hinged on a bolt 31 on the right folding door element 15. The other end of the clip 30 is a free end, i.e. it can move freely over the left joint part of the folding door element 14 and has a crank 32 which engages the bolt 33 which is located on the left joint part of the folding door element 14.

During the pivoting of the two folding door elements 14, 15 around the axis of the articulated arrangement the crank guide 32 of the clip 30 travels over the pin 33 to a catch position which is shown in FIG. 3 and which is formed by a shoulder in the crank guide 32.

The pin 33 traveling into the catch position in the crank guide 32 prevents the folding door elements 14, 15 from pivoting further in against one another. For this reason travel of the folding door elements along the frame is easily possible without the folding door element being able to tilt. Furthermore in this position cleaning of the glass doors is easily possible without their being moved by the cleaning process and having to be additionally fixed.

In order to pivot the folding door elements 14, 15 further against one another, only the clip 30 need be deflected by hand out of the position shown in FIG. 3 in the direction to the included angle between the folding door elements 14, 15 so that the pin 33 travels in farther along the crank guide and further folding of the folding door elements 14, 15 together around the joint against one another is possible.

FIG. 4 shows a second embodiment of an articulated arrangement between the door elements 14, 15. The articulated arrangement is not shown in this figure. In this case there is a flexible metal strip 40 which extends around the articulated arrangement on the outside. The flexible metal strip 40 has one fixed end 41 which is fixed in the glass holders 44 of the glass door 14. The other end 42 of the metal strip 40 is a free end and engages the opposite metal holders 45 of the second glass door element 15.

The free end 42 of the metal strip 40 has a catch element which is formed by a bolt 43 and which at an acute angle of 30° between the two glass door elements 14, 15 travels into a catch position and prevents further closing of the included angle between the glass doors 14, 15. This locking of the joint at an acute angle of 30° between the glass door elements 14, 15 facilitates the movement along the frame, as described above.

In order to further fold the folding door element together with the glass door elements 14, 15, the metal strip 40 must be briefly depressed by hand in order to take the catch element 43 out of the catch position and to enable further folding-in.

FIG. 5 shows a third embodiment of a hinge locking device which is formed by a special execution of the joint between the door elements 14, 15. An axially movable hinged pin 51 is inserted into the hinge here. The hinged pin 51 has a feather key 52 which for a certain axial position engages a corresponding groove arrangement 53 in the hinge and blocks the hinge in this angle position.

To disengage this hinge locking device only the hinged pin 51 need be pressed in axially so that the feather key 52 slips down axially out of the groove 53 and the articulated arrangement is released again.

It is also possible to combine several of the described joint locking devices to one another. This yields high reliability of the locking or it is possible to implement the locking on several intermediate positions of the angle which is included between the door elements 14, 15.

1. A sliding door system with a frame (1, 1′, 2, 2′) which holds one or more sliding doors which supported in or on the frame (1, 1′, 2, 2′) can be moved horizontally along the frame (1, 1′, 2, 2′), characterized in that the sliding doors are made as folding door elements (11, 12, 13) in which two door elements (14, 15) are hinged to one another by means of an articulated arrangement on a hinge line (16) which runs in the middle vertically between the door elements, the articulated arrangement being pivotable out of the plane of the frame so that the two door elements (14, 15) can be pulled out perpendicular to the plane of the frame and lie in one open position flat on one another.

2. The sliding door system as claimed in claim 1, wherein the sliding doors (11, 12, 13) are supported suspended or upright in or on the frame (1, 1′, 2, 2′).

3. The sliding door system as claimed in claim 1 wherein the sliding doors (11, 12, 13) on their left side and on their right side have bearings which can move up or down, especially castors (17, 18) or sliders by means of which they are movably supported in a guide rail of the frame (1, 1′, 2, 2′), these bearings remaining in the plane of the frame when the articulated arrangement is pivoted out.

4. The sliding door system as claimed in claim 1 wherein the sliding doors (11, 12, 13) can be moved in any directions along the frame (1, 1′, 2, 2′) and can be folded together both on the left end of the frame and also on the right end (4) of the frame.

5. The sliding door system as claimed claim 1 wherein the sliding door system on the left or right side has a wing or sliding wing (5, 6), especially a glass door, the wing being coupled to the frame (1, 1′, 2, 2′) by means of hinges.

6. The sliding door system as claimed in claim 1 wherein the sliding doors (11, 12, 13) or wings (5, 6) have a safeguard or lock, especially a pin safeguard or a spring-loaded catch against unwanted opening.

7. The sliding door system as claimed in claim 1 wherein the sliding doors (11, 12, 13) in the region of the articulated arrangement, especially in the axial alignment of the axis (16) of rotation of the articulated arrangement, are supported to be able to move by means of a castor or slider in a guide rail of the frame (1, 1′, 2, 2′), the guide rail in one open position of the sliding door (11, 12, 13) having a recess so that the castor(s) or slider(s) which is(are) located in the region of the articulated arrangement especially in the axial alignment of the axis (16) of rotation of the articulated arrangement can emerge perpendicular to the plane of the frame out of the guide rail and thus out of the plane of the frame.

8. The sliding door system as claimed in claim 1 wherein the sliding doors (11, 12, 13) in the region of the articulated arrangement, especially in the axial alignment of the axis (16) of rotation of the articulated arrangement by means of a castor or a slider or a pin in a guide rail of the frame movably engage, the castor(s) or slider(s) or pin(s) located in the region of the articulated arrangement, especially in the axial alignment of the axis (16) of rotation of the articulated arrangement can be released from the guide rail so that the region of the articulated arrangement can emerge perpendicular to the plane of the frame out of the guide rail and thus out of the plane of the frame.

9. The sliding door system as claimed in claim 1 wherein one or both door elements (14, 15) of the folding door elements (11) are made as glass doors, especially as frameless glass doors.

10. The sliding door system as claimed in claim 1 wherein the frame (1, 1′, 2, 2′) is formed by several frame sections which have one or more angles (α) so that several planes of the frame are formed which include angles (α) among one another, the sliding doors (11, 12, 13) being movable especially beyond the angle (α) along the frame sections.

11. The sliding door system as claimed in claim 1 wherein there are a plurality of folding door elements (11, 12, 13) which can be moved on one or both sides along the plane of the frame to an open position, and the folding door elements (11, 12, 13) can be pulled out by the respective articulated arrangement being pivoted out of the plane of the frame so that the folding door elements (11, 12, 13) on one or both sides of the frame in the open position form a package of door elements which lie flat on one another.

12. The sliding door system as claimed in claim 1 wherein the articulated arrangement has a locking device by means of which the articulated arrangement can be locked regardless of the angle, especially at an acute angle between the two door elements (14, 15) so that a pivoting motion of one door element (14) against the other door element (15) is blocked.

13. The sliding door system as claimed in claim 1 wherein the articulated arrangement has a locking device by means of which the articulated arrangement can be locked at an angle of 180° between the two door elements (14, 15) so that a pivoting motion of one door element (14) against the other door element (15) is blocked.

14. The sliding door system as claimed in claim 1 wherein the articulated arrangement has a locking device which is formed by a clip (30) which is coupled to one door element (14) and whose free end is guided by means of a crank guide (32) with respect to the other door element (15), the crank guide (32) having at least one locking position in which the clip (30) detachably latches so that the articulated arrangement is locked in at least one intermediate position between the closed position and complete opening, especially at an acute angle between the two door elements (14, 15) so that a further pivoting motion of one door element (14) against the other door element (15) in this intermediate position is blocked.

15. The sliding door system as claimed in claim 1 wherein the articulated arrangement has a locking device which is formed by an axially movable, especially spring-loaded hinged pin (51) which is located torsionally strong to a first hinge part and has a feather key (52) which in the disengaged axial position engages a groove (53) of a second hinge part and locks the articulated arrangement so that a pivoting motion of one door element (14) against the other door element (15) is blocked.

16. The sliding door system as claimed in claim 1 wherein the articulated arrangement has a locking device which is formed by flexible strip (40) which extends around the articulated arrangement on the outside and which is attached to one door element (14) and whose free end (42) has a catch element (43) which in at least one intermediate position travels detachably into a recess on the other door element (15) so that the articulated arrangement is blocked in at least this intermediate position between the closed position and complete opening, especially at an acute angle between the two door elements (14, 15) so that further pivoting motion of one door element (14) against the other door element (15) in this intermediate position is blocked.

17. The sliding door system as claimed in claim 1 wherein the articulated arrangement has at least one pretensioned spring, especially a leaf spring or torsion spring which when an opening angle of 180° between the two hinged door elements (14, 15) is not reached causes a reduction of the angle included between the two hinged door elements (14, 15) and thus automatic folding of the folding door element (11, 12, 13).

18. The sliding door system as claimed in claim 1 wherein the articulated arrangement between the two hinged door elements (14, 15) is detachable in order to be able to line up the two door elements independently of one another and to be able to move along the frame, especially wherein the articulated arrangement is formed by one or more hinges, hinge parts which can be turned against one another being coupled by means of a bolt, the bolt being axially movable at least insofar as one hinge part is released.

19. The sliding door system as claimed in claim 2 wherein the sliding doors (11, 12, 13) on their left side and on their right side have bearings which can move up or down, especially castors (17, 18) or sliders by means of which they are movably supported in a guide rail of the frame (1, 1′, 2, 2′), these bearings remaining in the plane of the frame when the articulated arrangement is pivoted out.

20. The sliding door system as claimed in claim 2 wherein the sliding doors (11, 12, 13) can be moved in any directions along the frame (1, 1′, 2, 2′) and can be folded together both on the left end of the frame and also on the right end (4) of the frame and wherein the sliding door system on the left or right side has a wing or sliding wing (5, 6), especially a glass door, the wing being coupled to the frame (1, 1′, 2, 2′) by means of hinges and wherein the sliding doors (11, 12, 13) or wings (5, 6) have a safeguard or lock, especially a pin safeguard or a spring-loaded catch against unwanted opening.
